(19) United States
(12) Patent Application Publication
(10) Pub. No.: US 2008/0306821 A1
(43) Pub. Date: Dec. 11, 2008

(54) System and Method of Driving Commodity Consumers to Selective Retail Locations

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/030,032

(22) Filed: Feb. 12, 2008

Related U.S. Application Data
(60) Provisional application No. 60/900,845, filed on Feb. 12, 2007.
(60) Provisional application No. 60/966,565, filed on Aug. 29, 2007.

(51) Int. Cl. G06Q 30/00; G06Q 99/00

(52) U.S. Cl. 705/14; 705/1

(57) ABSTRACT

A system and method for driving commodity consumers to selective locations allows an operator of a price protection product to enter into agreements with locations offering a commodity such that the locations provide incentives for purchasers or consumers of the commodity to purchase the commodity at the location. The operator of the price protection system may enter into agreements with purchasers to provide information about the locations offering the incentives.

### CROSS-REFERENCE TO RELATED APPLICATIONS

This application claims priority from Provisional Patent Applications No. 60/900,845, filed Feb. 12, 2007, entitled “SYSTEM AND METHOD OF DRIVING COMMODITY CONSUMERS TO SELECTIVE RETAIL LOCATIONS” and No. 60/966,565, filed Aug. 29, 2007, entitled “SYSTEM AND METHOD OF DRIVING COMMODITY CONSUMERS TO SELECTIVE RETAIL LOCATIONS,” the entire contents of which are expressly incorporated herein by reference for all purposes.

### FIELD OF THE INVENTION

The present invention relates generally to influencing purchasing behaviors of commodity consumers. More particularly, the present invention relates to a system and method of communicating in real-time relevant information and analytics about selective retail locations carrying particular commodities to influence purchasing behaviors of commodity consumers.

### BACKGROUND OF THE INVENTION

Making a decision to purchase a commodity can be a very difficult process, particularly if that commodity tends to fluctuate in an unpredictable manner. For example, as the price of crude oil continues to fluctuate globally and fluidly, motor fuel prices at the pump can change from location to location on a daily or even hourly basis. In such a volatile market, it is extremely difficult for fleet managers and consumers alike to make sound decisions on where, how much, when, or even what fuel grade to buy and the terms on which to buy the commodity.

### SUMMARY OF THE INVENTION

Embodiments disclosed herein provide a system and method of communicating, in real-time or near real-time, relevant information and analytics about selective retail locations carrying particular commodities to influence purchasing behaviors of commodity consumers. Embodiments disclosed can be implemented, utilizing advanced communication mechanisms, to drive commodity consumers to retail locations carrying various commodities and therefore are not limited to any particular types of commodities and/or retail products.

One embodiment may be directed to a method for driving commodity consumers to a selective location among a plurality of locations, including identifying one or more locations offering a commodity within a geographic boundary, selecting a location from the one or more identified locations, and communicating information to a consumer associated with a price protection product about the location. The location may be identified based on information associated with the location. The method may include establishing an agreement between a provider of a price protection product and a location, wherein the provider of the price protection product is operable to communicate information about the location.

In some embodiments, a price associated with a price protection product comprises an index price. In some embodiments, a price associated with a price protection product comprises an aggregate price determined for locations within a geographic boundary.

In some embodiments, selecting a location from the one or more locations comprises selecting the location having an agreement with a provider of the price protection product. In some embodiments, selecting a location from the one or more locations is based on price information corresponding to the location. In some embodiments, selecting a location from the one or more locations is based on location information. In some embodiments, selecting a location from the one or more locations is based on added services.

In some embodiments, the method may include filtering one or more locations. In some embodiments, filtering comprises determining a threshold value for the commodity and identifying one or more locations that meet the threshold value. In some embodiments, communicating information to a consumer about the location comprises communicating information about one or more of location, distance, price per unit, savings per unit, and added services offered at the location. In some embodiments, the provider of the price protection product is operable to provide an incentive for the commodity for consumers of the price protection product to purchase the commodity at a selective retail location.

One embodiment disclosed herein may be directed to a system for driving commodity consumers to a selective location among a plurality of locations. The system may include a provider of a price protection product having an agreement with one or more locations offering a commodity at a selected price among a plurality of locations, wherein each of the one or more locations is capable of providing the commodity for a purchaser of a price protection product from lock price provider, a database for maintaining information about one or more of the locations, the purchaser, the price protection product, and a consumer, wherein the purchaser corresponds to one or more consumers, and a communications device for communicating information to the consumer of the commodity. In some embodiments, one or more locations comprise an affinity partner. In some embodiments, one or more locations comprise a preferred provider.

One embodiment disclosed herein may be directed to a computer-readable medium carrying program instructions executable by a processor to identify one or more locations offering a commodity within a geographic boundary, select a location from the one or more identified locations, wherein the location is identified based on information associated with the location, and communicate information to a consumer associated with a price protection product about the location. In some embodiments, the instructions are operable to select the location having an agreement with a provider of the price protection product. In some embodiments, the instructions are operable to filter one or more locations. In some embodiments, the instructions are operable to determine a threshold value for the commodity and identify one or more locations that meet the threshold value. In some embodiments, the instructions are operable to communicate information about one or more of location, distance, price per unit, savings per unit, and added services offered at the location.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a diagram of an exemplary system for driving consumers to a selective retail location;

FIG. 2 depicts a simplified flow diagram of an exemplary method for driving consumers to a selective retail location; and

FIG. 3 depicts a simplified flow diagram of an exemplary method for establishing a network of affinity partners.

### DETAILED DESCRIPTION

The invention and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Before discussing specific embodiments, an exemplary hardware architecture for implementing embodiments of the present invention will now be described. Specifically, one embodiment of the present invention can include a computer communicatively coupled to a network (e.g., the Internet). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc.), or the like. In embodiments of the invention, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (e.g., a HD). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of complied C++, Java, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. In some embodiments, a product, process, article, or apparatus that comprises a list of elements is not necessarily limited only those elements but may include other elements not expressly listed or inherent to such product, process, article, or apparatus. Further, unless expressly stated to the contrary, “or” refers to an inclusive or and not to an exclusive or. In some embodiments, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms.

Language designating such non-limiting examples and illustrations includes, but is not limited to: “for example,” “for instance,” “e.g.,” “in one embodiment.”

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves in the market. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

Reference is now made in detail to the exemplary embodiments, examples of which are illustrated in the accompanying drawings. Wherever possible, the same reference numbers will be used throughout the drawings to refer to the same or like parts (elements).

In some cases, it may be desirable, such as achieving a business goal, to drive commodity consumers to certain retail locations. As an example, one embodiment can be implemented to influence consumer gasoline purchasing behavior by communicating real-time information and analytics about gasoline prices for locations within a geographic boundary. Embodiments may also be implemented to influence commodity consumers to purchase heating oil, aviation fuel, diesel fuel, emission credits such as carbon offsets, and other energy-related products. Within this disclosure, a commodity consumer may refer to any person that purchases a commodity, including, but not limited to, commercial entities, fleet managers and drivers, individual end users, etc. One example of a business goal may be to provide some advantages to the purchaser(s), the retail location(s), and/or the producer of a commodity. It is possible that a purchaser may also be a consumer and vice versa. The term “producer” may refer to any and all parties who contribute to getting the commodity to retail locations. Examples of producers may include, but are not limited to, manufacturers, suppliers, brokers, or a combination thereof. Another example of a business goal may be directed to cross selling products and/or services provided by third parties and/or partners at the same retail locations to where traffic is directed

Embodiments disclosed herein can be readily implemented in conjunction with a price protection system that provides price protection on retail commodities. Examples of such a price protection system can be found in U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS,” which is incorporated herein by reference.

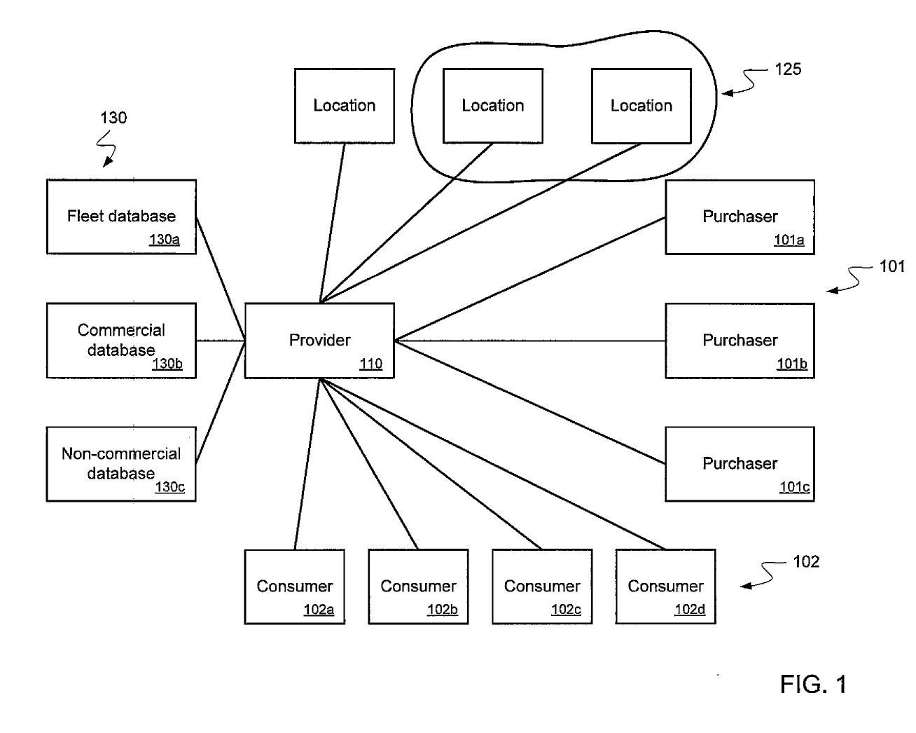

FIG. 1 depicts an exemplary embodiment of a system for driving commodity consumers to selective locations. In FIG. 1, one or more purchasers 101 may purchase price protection agreements for a commodity from operator of price protection system 110 (also referred to as “provider 110”). Purchasers 101 may include fleet manager 101a, commercial purchaser 101b, non-commercial purchaser 101c, etc. Purchaser 101 may purchase a price protection agreement from provider 110 over a network such as the Internet, via a sales associate, etc. Provider 110 may enter into an agreement with one or more locations 125 that offer the commodity to form network 120 of providers 125a. Provider 110 may select locations 125 offering the retail commodity within a geographic boundary and communicate information to consumers 102 identifying one or more locations 125 offering the commodity. In some embodiments, purchaser 101 may be associated with one or more consumers 102. For example, purchaser 101a may be a fleet manager associated with multiple fleet vehicles 102a₁₋ₙ, purchaser 101b may be a commercial entity associated with vehicle 102b, and purchaser 101c may be an individual associated with vehicle 102c. Thus, consumers 102a₁₋ₙ may purchase a commodity from retail location 125 under a price protection agreement purchased from provider 110 by purchaser 101a, consumer 102b may purchase a commodity from retail location 125 under a price protection agreement purchased from provider 110 by purchaser 101b, consumer 102c may purchase a commodity from retail location 125 under a price protection agreement purchased from provider 110 by purchaser 101c, etc. Retail locations 125 may form network 120 of affinity partners 125a or may be preferred providers 125b, discussed below. In some embodiments, provider 110 may analyze information about retailers 125, consumers 102, and purchasers 101. Provider 110 may store information in one or more databases 130, such as fleet database 130a, commercial database 130b, and non-commercial database 130c, may dynamically determine information, or may use some combination thereof. For example, provider 110 may maintain a list in database 130 of physical addresses and directions for locations 125, but may dynamically determine some information such as the price offered at selective locations 125a.

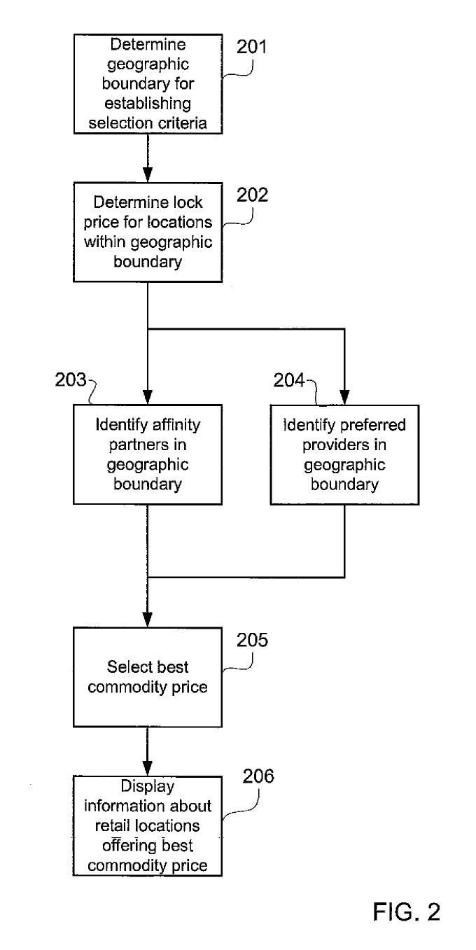

FIG. 2 is a simplified flow diagram representatively depicting a method of driving traffic to locations 125 according to one embodiment. As described above, the method can be embodied in computer-executable instructions carried on one or more computer-readable media residing in one or more data processing systems or computers. One embodiment may be implemented as a messaging service, dynamically informing, in real-time or near real-time, the most beneficial routing and location information on one or more retailers based on a plurality of parameters, including hedged prices on certain retail commodities.

In step 201, a geographic boundary may be determined based on purchaser 101 or consumer 102 or both. In some embodiments, a geographic boundary may be determined by manually entering information, such as a postal code, a city designation, a state designation, a country code, or some other Designated Market Area (DMA). For example, purchaser 101a may be a fleet manager and may designate Texas, Arkansas, and Louisiana as the geographic boundary. In some embodiments, a geographic boundary may be determined dynamically. For example, a GPS receiver may update geographic positioning of consumer 102 at any time and may change or update the geographic boundary in real time based on the geographic location of the vehicle. As specific examples, such a GPS receiver may be implemented in a vehicle, a phone, a mobile device, a computer, etc. In some embodiments, laws and regulations may affect how a geographic boundary may be defined.

In step 202, within any defined geographic boundary, one or more locations 125 offering the commodity within the geographic boundary may be identified. Information such as price information, location information, added services and the like associated with locations 125 within the geographic boundary may be used to identify locations 125. In some embodiments, price information may include a lock price. In some embodiments, lock prices correspond to the prices at which, by purchasing a price protection product, consumer 102 may purchase the corresponding commodity if the retail price should exceed the lock price. However if the retail price of the commodity falls below the corresponding lock price, consumer 102 may purchase the commodity at the retail price. A lock price may be based on a price or a range of prices that purchaser 101 has agreed to pay provider 110 regardless of the price retail location 125 is offering for the commodity. In some embodiments, the lock price may be based on an index or may be determined by provider 110. For more teachings on determining a retail price within a geographic boundary or the lock price, readers are directed to co-pending U.S. patent application Ser. No. (Attorney Docket No. PRICE1110-2), filed Feb. ______, 2008, entitled “SYSTEM AND METHOD OF DETERMINING A RETAIL COMMODITY PRICE WITHIN A GEOGRAPHIC BOUNDARY,” co-pending U.S. patent application Ser. No., filed Feb. ______, 2008, which claims priority from Provisional Application No. 60/922,427, filed Apr. 9, 2007, entitled “SYSTEM AND METHOD FOR INDEX BASED SETTLEMENT UNDER PRICE PROTECTION,” and U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS,” all of which are incorporated herein by reference.

In step 203, locations 125a in network 120 (also referred to as “affinity partners”) may be identified. Affinity partners 125a may refer to locations 125 that may be affiliated with provider 110. In some embodiments, this affiliation may comprise an agreement between provider 110 and location 125a. For example, the agreement could stipulate that location 125a will provide a discount on the price of a commodity to purchaser 101 of a price protection product from provider 110, or that location 125a pays a fee to be affiliated with price protection system, etc. Per the contractual relationship, affinity partner 125a may provide a certain price reduction on the price of the commodity purchased by consumer 102. In terms of motor fuel commodities such as gasoline, such a price reduction may be referred to as “cents per gallon” or CPG reduction. This may be done in exchange for provider 110 promoting locations 125a through provider 110, such as a website, email, etc. In the case of gasoline, locations 125a may be gasoline stations or convenience stores. In the case of heating oils, retail locations 125a may be a delivery service. In the case of aviation fuel, locations 125a may be selected airports or fixed base operators (FBOs). In some embodiments, provider 110 may promote locations 125a through websites and other means as described below.

When consumer 102 purchases a commodity from affinity partner 125a, the contractual relationship between affinity partner 125a and provider 110 may be transparent to consumer 102. Their individual “lock prices” as specified in their commodity contracts are not changed or affected. In some embodiments, provider 110 may retrieve a list of affinity partners 125a from database 130. In some embodiments, affinity partners 125a for a fleet 102a may differ from affinity partners 125a for consumer 102b having a single vehicle or consumer 102c.

In some embodiments, provider 110 may want to determine a commodity price for non-affiliated retail locations 125b and determine the best price for these locations. For example, affinity partner 125a may not be available or may have undesirable commodity prices. In step 204, provider 110 may identify locations 125b which are not part of network 120 but may still offer the commodity at a desirable price or meet other selection criteria. In this example, such locations 125b may be referred to as “preferred providers”. Driving consumers 102 to these retailers 125b may increase profit to provider 110 due to the spread between the (lock) index price and the retail price (Index Spread). In this way, if consumer 102 goes to location 125b, and if its price is below the price against which the transaction is settled, provider 110 may gain some spread and/or consumer 102 may get some money back. In some embodiments, provider 110 can monetize this step whether a contractual relationship exists between location 125b and provider 110. As an example, step 204 can be implemented to perform an analysis of the estimated forward retail prices for gasoline on a store-by-store basis. One example of how this can be done is described in co-pending U.S. patent application Ser. No. ______ (Attorney Docket No. PRICE1120-1), filed Feb. ______, 2008, entitled “SYSTEM AND METHOD FOR ESTIMATING FORWARD RETAIL COMMODITY PRICE WITHIN A GEOGRAPHIC BOUNDARY,” which is incorporated herein by reference. In one embodiment, one function may perform a rebate analysis to determine the difference between the index price and the price paid to preferred provider 125b and give preferred provider 125a a portion of the savings (10%, 1 CPG, etc).

In some embodiments, step 204 can be implemented to identify retailers 125 who sell the commodity below an index price and include them as preferred providers 125b. In some embodiments, price protection contracts may be settled again an index. As an example, suppose purchaser 101a purchases a price protection product for 87 octane gasoline from provider 110 against an index price of $2.00 (i.e., the consumer is protected from paying more than $2.00/gallon based on the index price for retail 87 octane gasoline). If at some point during the term of the price protection product, consumer 102 purchases 87 octane gasoline when the index price is $2.50/gallon, consumer 102 is protected at $2.00 per gallon, regardless of whether 87 octane gasoline could be purchased at $2.01/gallon or $2.50/gallon. If there are several locations 195 offering 87 octane gasoline below the index price and consumer 102 opts to purchase at a location having an actual retail price at the pump of $2.25, consumer 102 would be responsible for paying the $2.00 and provider 110 would pay retail location 125b the remaining 25 cents, which is the difference between the index price of $2.00 for the price protection product and the retail price of $2.25. However, since consumer 102 purchased the commodity—the 87 octane gasoline—below the index price which, in this example, is $2.50, there is 25 cent per gallon economical benefit. In some embodiments, this benefit or a portion thereof may be passed on to consumer 102 to encourage purchasing 87 octane gasoline below the index price, and preferably at location 125b offering 87 octane gasoline at the lowest retail price. Thus, in addition to driving consumers 102 to certain retailers 125 to reduce the risk and/or moral hazard, provider 110 may drive consumers 102 to certain retailers 125 to generate and/or optimize profit via an index-based settlement. More detailed teachings on the index based settlement under price protection contracts and examples thereof can be found in Provisional Application No. 60/922,427, filed Apr. 9, 2007, entitled “SYSTEM AND METHOD FOR INDEX BASED SETTLEMENT UNDER PRICE PROTECTION,” which is incorporated by reference. These and other potential spreads can be used to generate further revenue by investment or savings.

Step 204 can be implemented to automatically track the prices and dynamically change the list of preferred providers 125b with the lowest prices within the geographic area. Since the lowest retail prices could change continuously, there may not be a need for a pre-existing relationship. Step 204 can be implemented to update the list in real-time or near real-time whenever changes occur. Co-pending U.S. patent application Ser. No. ______ (Attorney Docket No. PRICE1110-2), filed Feb. ______, 2008, entitled “SYSTEM AND METHOD OF DETERMINING A RETAIL COMMODITY PRICE WITHIN A GEOGRAPHIC BOUNDARY,” discloses ways to obtain prices for retail locations 125, including affinity partners 125a and preferred providers 125b.

In step 205, a commodity price may be selected from the prices offered by affinity partners 125a and preferred providers 125b. In some embodiments, only prices offered by affinity partners 125a may be selected. In some embodiments, only prices offered by preferred providers 125b may be selected. Step 205 can be implemented to aggregate data from steps 203 and 204 (i.e., information on the affinity partners and preferred providers) to select a complete list of retail locations 125 within the defined geographic area from which consumers 102 are to be encouraged to purchase the target retail commodity. In some examples disclosed herein, gasoline is the target retail commodity.

This list may contain both affinity partners 125a and non-affinity preferred providers 125b. In the case of gasoline, the list could contain stations with contractual relationships and stations with no contractual relationships. Both types of retail locations 125a and 125b may offer prices lower than a consumer's lock price. Step 205 may further comprise ranking stores 125 within a geographic area based on the lowest estimated forward prices on one or more target commodities. Example of such an area may include, but are not limited to, a county, neighborhood, zip code, driving route, state, etc. In the case of energy-related commodities, the one or more target commodities may refer to different grades of unleaded gasoline and types of diesel, heating oil, aviation fuel, carbon offsets, emission credits, etc. This analysis and hence its output can be dynamic in that it could change as frequently as determinations of location-by-location retail prices are made.

Step 205 may further comprise manipulating the list thus generated. For example, embodiments may filter information about one or more locations to determine a threshold value. A threshold value may be a percentage or a fixed number, to reduce the size of the list. Examples of a threshold may include, but are not limited to, top five percent of stores 125 within a geographic area based on the lowest price, all stores 125 within a county that have a price lower than the average for the county, etc. The ranking function and the manipulation functions may be performed independent from one another at any time in no particular order.

In step 206, information about selective retail locations 125a and 125b may be communicated to consumer 102 of a commodity to influence or drive them to selective retail locations 125a or 125b. In some embodiments, the information may include price information determined from step 205. Price information may include the price per unit offered by location 125, the cost to consumer 102, the savings to purchaser 101, or the like. Step 206 can be implemented to push or make available the list from step 205 to purchasers of the target retail commodity through a variety of communication mechanisms available to provider 110. In one embodiment, the push is done in realtime or near real-time. Step 206 may include providing incentives to consumers 102 and purchasers 101 either in advance or after purchase. An example of providing incentives in advance may be to provide a discount under the terms of a contract if they buy from affinity partners 125a. An example of providing incentives after purchase may be to provide a rebate if they buy from preferred providers 125b. For transactions that occur at a retail location 125 while that retail location is on the list (or if it is an affinity station 125a in general), providing a discount such as a CPG reduction may benefit provider 110. For example, during the reconciliation process at the back-end when a transaction processor calculates the liability (risk) for the retail price of a commodity such as gasoline, the CPG discount may be subtracted from the liability (if any) to determine the actual liability. Examples of such a transaction processor may include, but are not limited to, a fleet manager, fuel card partner, a financial institution, and so on. Similarly, transactions that occur at a retail location 125 while that location 125 is on the list may benefit the account holder such as purchaser 101 of a price protection product. This benefit may take many forms. For example, it may be in the form of rebates (calculated as some portion of the CPG discount offered by an affinity partner) applied directly to the customer's account after the purchase or “Bonus Points” which can be redeemed for services and merchandise either at affinity retail locations or through websites, including other partner's websites. For example, if purchaser 101 purchased a price protection agreement having a lock price on gasoline at $2.50/gallon and retail location 125 offers gasoline at $2.60/gallon, the price information may indicate the price shown at location 125 (which, in this example, is $2.60/gallon) the price consumer 102 will pay (which, in this example, is $2.50/gallon), the savings realized by purchaser 101 (which, in this example, is $0.10/gallon), or some combination thereof. If the commodity is offered by affinity partner 125a, the price information may indicate a cent-per-gallon rebate offered to purchaser 101. An example of such price information may indicate “Get a $0.03/gallon rebate for filling up at gasoline station X” or the like.

As an example, a push may include the following information:

Today in Travis County, for regular unleaded gasoline,
Your Lock Price is $3.00 per gallon;
Affinity #2 offers $2.95 per gallon; and
Preferred #4 offers $2.90 per gal.

Examples of suitable communication mechanisms include, but are not limited to: SMS (push/pull), emails, websites, automated or personal phone messages, instant-messaging systems, fleet management systems, satellite-enabled devices, in-car systems (such as On-Star®), GPS systems, Internet-enabled devices, etc. The portion of the list that is provided could be decided (filtered) based on information provided by purchaser 101 or consumer 102 (directly or indirectly), such as location, station preference, desire for other facilities or interest points such as dining, repair, etc. The choice of a suitable communication medium may be decided by the purchaser 101 or consumer 102, for example, by making a selection of preferences on the website(s) of the Lock Price Provider and/or its affiliate(s).

In some embodiments, lock prices do not fluctuate like retail prices. Provider 110 can therefore monetize this step based on its contractual relationships with affinity partners 125a and benefit from the reduction provided by affinity partners 125a.

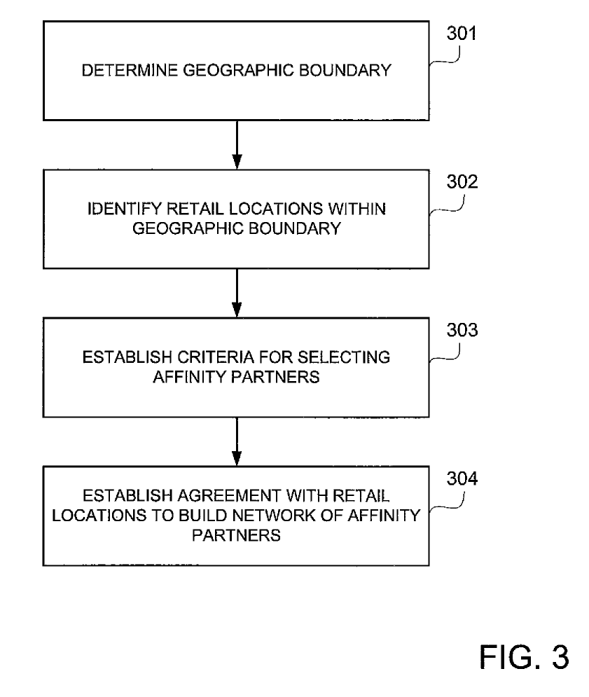

FIG. 3 depicts a simplified flow diagram of an exemplary method for developing network 120 of locations 125a. In step 301, a geographic boundary may be identified for developing network 120. A geographic boundary may be defined by a zip code, city limits, county lines, state lines, national boundaries, or some other DMA such as “all towns within 2 miles of Interstate Highway 35 (IH-35) between Dallas, Tex. and Austin, Tex.” In step 302, locations that sell a commodity within the geographic boundary are identified, which may be based on information about the location, a parent company, or the like. For example, in some embodiments, only locations 125 having a car wash, all affiliated or franchise locations, all independent locations, or meeting some other criteria may be identified. In some embodiments, all locations 125 within the geographic boundary may be identified.

In step 303, provider 110 of a price protection product may establish criteria for selecting affinity partners 125a. Criteria may include features that provider 110 knows purchasers 101 and/or consumers 102 will want. Examples include, but are not limited to, proximity to highways, commercial areas, business districts, restaurants, etc., services such as car washes, full-service car care, etc., and prices for the commodity. Criteria may include location 125 being part of a nationwide chain of locations 125, willingness to settle against an index, or the like. In step 303, provider 110 may filter network 120 or otherwise identify retail locations 125 meeting selective criteria. In some embodiments, network 120 may be filtered to determine only those locations 125 that have added services, satisfy selective price criteria, or that meet other criteria. Examples of added services may include, but are not limited to, car wash, food and drink, shop, on-site mechanics, and so on. Examples of selective price criteria may include, but are not limited to, willingness to settle against an index price, provide a CPG rebate, etc. Examples of other criteria may include, but are not limited to, acceptance of selective credit cards, distance to a major road or highway, etc. Thus, embodiments disclosed herein may establish multiple networks 120 based on different information and criteria. In this way, provider 110 may offer different price protection products to different purchasers 101 for different consumers 102.

In step 304, provider 110 may enter into an agreement with one or more locations 125 to form network 120 of affinity partners 125a. An agreement between provider 110 and affinity partner 125 may be tailored to each affinity partner 125a based on a price for the commodity, criteria associated with affinity partner 125a, or the like.

In the foregoing specification, the invention has been described with reference to specific embodiments. However, one of ordinary skill in the art will appreciate that various modifications and changes can be made without departing from the spirit and scope of the invention disclosed herein. Accordingly, the specification and figures disclosed herein are to be regarded in an illustrative rather than a restrictive sense, and all such modifications are intended to be included within the scope of the following claims and their legal equivalents.

What is claimed is:

1. A method for driving commodity price protection consumers to commodity retail locations, comprising:
identifying a plurality of locations offering a commodity within a geographic boundary;
selecting at least one location from the plurality of locations offering the commodity within the geographic boundary; and
communicating information about the at least one location selected from the plurality of locations offering the commodity within the geographic boundary to a consumer of a price protection product associated with the commodity.

2. The method of claim 1, further comprising:
providing the information about the at least one location selected from the plurality of locations offering the commodity within the geographic boundary to the consumer via a Website or portal maintained by a provider of the price protection product associated with the commodity.

3. The method of claim 1, wherein the price protection product associated with the commodity enables the consumer to purchase a quantity of the commodity at a first price that is different from a second price for the commodity at the at least one location.

4. The method of claim 3, wherein the second price for the commodity at the at least one location is lower than an index price for the commodity.

5. The method of claim 3, wherein the second price for the commodity at the at least one location is same or lower than retail prices for the commodity at other locations within geographic boundary.

6. The method of claim 1, wherein selecting the at least one location from the plurality of locations offering the commodity within the geographic boundary comprises determining whether the at least one location has an agreement with a provider of the price protection product associated with the commodity.

7. The method of claim 1, wherein selecting the at least one location from the plurality of locations offering the commodity within the geographic boundary comprises comparing retail prices for the commodity at the one or more locations.

8. The method of claim 1, wherein selecting the at least one location from the plurality of locations offering the commodity within the geographic boundary comprises comparing the plurality of locations based on a plurality of criteria and wherein the plurality of criteria includes location information and services information corresponding to each of the plurality of locations.

9. The method of claim 1, further comprising filtering the plurality of locations within the geographic boundary.

10. The method of claim 9, wherein filtering the plurality of locations within the geographic boundary comprises:
determining a threshold value for the commodity; and
identifying locations that meet the threshold value.

11. The method of claim 1, wherein the information about the at least one location comprises location information, distance to a point of interest, retail price per unit of the commodity, savings per unit of the commodity, and services offered at the at least one location.

12. The method of claim 1, further comprising providing an incentive to the consumer of the price protection product to purchase the commodity at the at least one location.

13. A system, comprising:
a provider of a price protection product for a commodity;
a plurality of locations communicatively coupled to the provider, wherein the plurality of locations offer the commodity within a geographic boundary;
a database communicatively coupled to the provider for maintaining information about the plurality of locations;
a processor,
a computer-readable medium carrying program instructions executable by the processor to perform:
selecting at least one location from the plurality of locations offering the commodity within the geographic boundary; and
a communications device for communicating information about the at least one location to a consumer of the price protection product for the commodity.

14. The system of claim 13, wherein the at least one location comprises an affinity partner.

15. The system of claim 13, wherein the at least one location comprises a preferred provider.

16. A computer-readable medium carrying program instructions executable by a processor to perform:
identifying a plurality of locations offering a commodity within a geographic boundary;
selecting at least one location from the plurality of locations offering the commodity within the geographic boundary; and
communicating information about the at least one location selected from the plurality of locations offering the commodity within the geographic boundary to a consumer of a price protection product associated with the commodity.

17. The computer-readable medium of claim 16 carrying program instructions operable to provide the information about the at least one location selected from the plurality of locations offering the commodity within the geographic boundary to the consumer via a Website or portal maintained by a provider of the price protection product associated with the commodity.

18. The computer-readable medium of claim 16 carrying program instructions operable to filter the one or more locations within the geographic boundary.

19. The computer-readable medium of claim 18 carrying program instructions operable to:
determine a threshold value for the commodity; and
identify locations that meet the threshold value.

20. The computer-readable medium of claim 16 carrying program instructions operable to communicate an incentive to the consumer of the price protection product to purchase the commodity at the at least one location.
